(19) United States
(12) Patent Application Publication
(10) Pub. No.: US 2010/0128164 A1
(43) Pub. Date: May 27, 2010

(54) IMAGING SYSTEM WITH A DYNAMIC OPTICAL LOW-PASS FILTER

(76) Inventors: Branko Petljanski, Woodland Hills, CA (US); John Galt, Glendale, CA (US)

Correspondence Address: Karish & Bjorgum, PC, 510 W. 6th Street, Suite 308, Los Angeles, CA, 90014, US

(21) Appl. No.: 12/622,988

(22) Filed: Nov. 20, 2009

Related U.S. Application Data
(60) Provisional application No. 61/117,036, filed on Nov. 21, 2008.

(51) Int. Cl. H04N 5/225

(52) U.S. Cl. 348/360; 348/E05.024

(57) ABSTRACT

A filter system for use with an image capture device having an imager with a plurality of imaging elements, the filter system having: a filter element for movably directing light to different imaging elements on the imager; and a manipulator for changing the orientation of the filter element during an exposure to achieve an optical low-pass filter.

### CROSS REFERENCE TO RELATED APPLICATIONS

The present application claims priority of U.S. Provisional Patent Application No. 61/117,036, filed on Nov. 21, 2008, entitled “Image Improvement Using Active Optical Low Pass Filter”, the entire contents of which are hereby incorporated herein by reference.

### BACKGROUND

The present invention relates to digital image devices, and more specifically to a dynamic optical low-pass filter for digital imaging devices with fixed sampling structures.

Digital imagers such as CCDs, CMOS imagers and other devices which contain a plurality of imaging elements (PIXELs) generate discrete signals instead of continuous signals. The Nyquist-Shannon sampling theorem states that in order to acquire a discrete equivalent of a continuous signal, the signal should be sampled at least twice the maximum bandwidth of the continuous signal. When a continuous tone image is sampled by a device with a discrete sampling structure, frequencies present in the scene tend to exceed the Nyquist frequency because of the practical constraints of the system. Violation of the Nyquist-Shannon sampling theorem results in aliasing, an irreversible process that permanently contaminates the discrete equivalent of continuous scenes.

In some instances aliasing is ignored. In other instances, aliasing is dealt with by limiting frequencies above the Nyquist frequency in the scene that is to be digitized. A device in the imaging system that limits or reduces high frequencies so the frequencies to be digitized are below the Nyquist frequency is called an anti-aliasing filter or an optical low-pass filter (OLPF).

Various proposed optical low-pass filters have been proposed, including birefringent filters and phase noise filters. Birefringent filters use a birefringent material which has an optical characteristic of double refraction, where an incoming ray of light is decomposed into two rays. Passing a continuous image through a birefringent based OLPF decomposes it into duplicate images that reach the sampling device. The resulting spatial offsets affect only the high frequency content of the image. The affected frequencies are a function of the specific spatial offsets which in turn are a function of the thickness and the refractive index of the birefringent material.

However, the filtering characteristics of birefringent optical low pass filters are fixed by their design criteria and not variable after manufacture. The frequencies suppressed by the OLPF and the effect of the OLPF on coarse parts of the image do not change regardless of changes in other components of the capturing system or the scene to be captured.

There are several instances in which it is desirable to change the characteristics of an OLPF in a controlled way, for instance when it is desirable to compensate for the performance of a particular lens or the characteristics of a lens that vary with aperture, or when the spatial characteristics of an imager change due to binning or sub-sampling, or when integration time and subject or camera movement results in a reduction of high frequency content. In all of these instances, an optical low pass filter whose characteristics could be altered would result in an improved image quality.

Thus, there is a need for an improved optical low-pass filter that remedies the shortcomings of the prior art.

### SUMMARY

Accordingly, the present invention, according to an embodiment is directed to a filter system for use with an image capture device having an imager with a plurality of imaging elements, the filter system having a moveable filter element that can direct light to different imaging elements on the imager; and a manipulator for changing the orientation of the filter element during an exposure to achieve an optical low-pass filter. The filter element may be a parallel optical window or a rigid mirror. The image capture device may further have a lens, the filter element is positionable between the imager and the lens of the image capture device.

The image capture device may also have a filter controller for controlling the manipulator. Optionally, the image capture device has a motion sensor electrically coupled to the filter controller and the filter controller is configurable to modify the manipulator in response to motion sensed by the motion sensor. Additionally, the filter controller may be configured to modify the low pass filter or disable the manipulator as a function of the lens aperture or other variable lens characteristics.

The present invention, according to an embodiment, is also directed to a method for filtering image frequencies in an image capture device having a lens, an imager having a plurality of imaging elements, a rotatable filter element positioned between the lens and the imager, and a controller, the method having the step of rotating the filter element in a predetermined pattern to move an image to at least two different locations on the imager during an exposure. The filter element may be rotated to place the image at different locations on the imager for different lengths of time. Optionally, the filter element is rotated to move the image to at least 4 different locations on the imager during an exposure. The filter element may be rotated to move the image in two dimensions.

In an additional embodiment, the image capture device has a motion sensor and the method further includes the step of altering the pattern of filter element rotation to change at least one of the number different image locations, the time spent on at least one image location, and the distance between image locations during an exposure in response to motion sensed by the motion sensor. In an additional embodiment, the image capture device has a motion sensor and the method further includes the step of stopping rotation of the filter element in response to motion sensed by the motion sensor.

In an embodiment, the lens in the image capture device is interchangeable and the image capture device further comprises a memory for storing information about various lenses; and the method further comprises the steps of: identifying the lens; retrieving from the memory information about the identified lens; and altering the pattern of filter element rotation to change at least one of the number different image locations, the time spent on at least one image location, and the distance between image locations during an exposure in response to information about the identified lens.

Additionally, the method may include the steps of: determining an aperture setting of the lens; and altering the pattern of filter element rotation to change at least one of: the number of different image locations, the time spent on at least one image location, and the distance between image locations during an exposure in response to the aperture setting of the lens.

In an another embodiment, the method includes the steps of: determining an aperture setting of the lens; and disabling rotation of the filter element in response to optical diffraction effects caused by small lens apertures; such as for example disabling rotation of the filter element in response to an aperture setting higher than F16. In another embodiment, the method includes the step of altering the pattern of filter element rotation to change at least one of: the number of different image locations, the time spent on at least one image location, and the distance between image locations during an exposure with pixel binning or sub-sampling in the imager.

In an additional embodiment, the present invention is directed to an image capture device having: a lens having a variable aperture; an imager having a plurality of imaging elements; and a means for movably directing light to different imaging elements on the imager, the means for movably directing light being positioned between the lens and the imager. The means for movably directing light moves an image to at least two different locations on the imager during an exposure to achieve an optical low-pass filter.

In an additional embodiment, the image capture device also has a controller electrically coupled to the lens, the imager and the means for movably directing light, and wherein the controller is configured to control the means for movably directing light to change at least one of: a number of different image locations, a time spent on at least one image location, and a distance between image locations during an exposure in response to an aperture setting of the lens. Optionally, the image capture device also has a motion detector for detecting motion of the image capture device; and wherein the controller disables the means for moving light in response to motion detection by the motion detector.

### THE DRAWINGS

A better understanding of the present invention will be had with reference to the accompanying drawings in which:

FIG. 1 is a schematic diagram of an image capture system having a dynamic optical low-pass filter according to an embodiment of the present invention;

FIG. 2 is a schematic diagram of a dynamic optical low-pass filter according to an embodiment of the present invention;

FIG. 3 is a schematic diagram of the operation of a parallel optical window usable in the dynamic optical low-pass filter of FIG. 2;

FIG. 4 is a schematic diagram of light passing through the parallel optical window of FIG. 3;

FIG. 5 is a schematic diagram of a rigid mirror usable in the dynamic optical low-pass filter of FIG. 2;

FIG. 6 is a schematic illustration of movement of an image to different locations on an imager during an exposure, such as through use of a dynamic optical low-pass filter;

FIG. 7 is a diagram of the theoretical modulation transfer functions of a three-tap dynamic optical low-pass filter with three different spatial distances between taps;

FIG. 8 is a graph of four test system modulation transfer function measurements with a rectangle filter having 2, 3, 4 and 10 taps; and

FIG. 9 is a graph of six test system modulation transfer function measurements with a 3 tap rectangle filter of varying distances between taps.

### DESCRIPTION

In the following description of preferred embodiments, reference is made to the accompanying drawings that form a part hereof, and in which is by way of illustrations specific embodiments in which the invention may be practiced. It is to be understood that other embodiments may be utilized and structural changes may be made without departing from the scope of the preferred embodiments of the present invention.

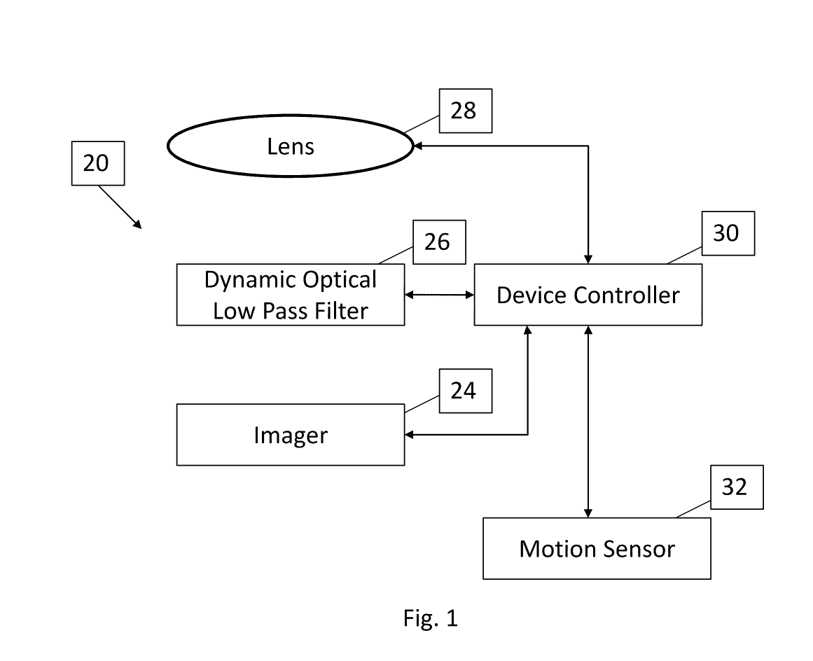

The present invention, according to an embodiment, is directed to a digital image capture system 20 having a dynamic optical low-pass filter. As shown in FIG. 1, a system 20 according to an embodiment of the present invention, has an imager 24 and a dynamic optical low-pass filter 26 positioned and oriented to direct light onto the imager. Optionally, the system includes a lens 28 and the dynamic optical low-pass filter 26 is positioned between the lens 28 and the imager 24. The system has a device controller 30 for controlling the imager 24. In a preferred embodiment, the device controller 30 communicates with the lens 28 to ascertain lens identification information and the aperture setting of the lens 28. Preferably, the device controller 30 also communicates with a motion sensor 32.

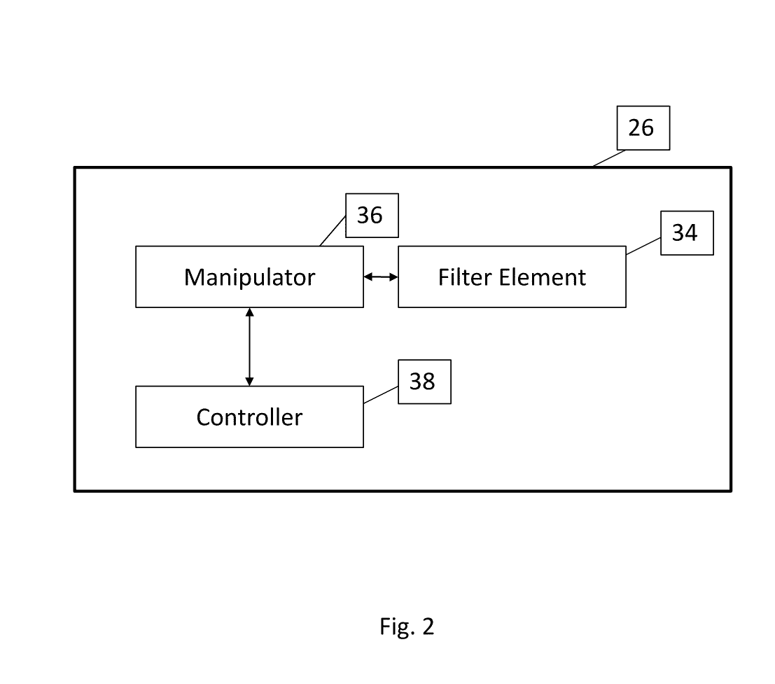

As shown in FIG. 2, according to an embodiment of the present invention, the dynamic optical low-pass filter 26 has a filter element 34, a manipulator 36 that alters the orientation of the filter element 34 and a filter controller 38 that controls the manipulator 36. As explained in more detail below, when operated, the dynamic optical low-pass filter 26 redirects light from an image to be captured onto multiple areas of the imager during an exposure.

In a first embodiment of the present invention, the filter element 34 is a parallel optical window that has two rotational degrees of freedom; pitch and yaw (x- and y-axis rotations). In a second embodiment of the present invention, the filter element 34 is a rigid mirror that has two rotational degrees of freedom; pitch and yaw (x- and y-axis rotations). Carefully controlled x- and y-axis rotations of the window or the mirror result in a manipulation of a point spread function (PSF) of the system. Manipulation of the point spread function of the optics before the image is digitized alters the frequency components of imaged continuous scenes. Different paths and velocities of the filter element 34 lead to different filtering effects.

### A Parallel Optical Window Based Optical Low-Pass Filter

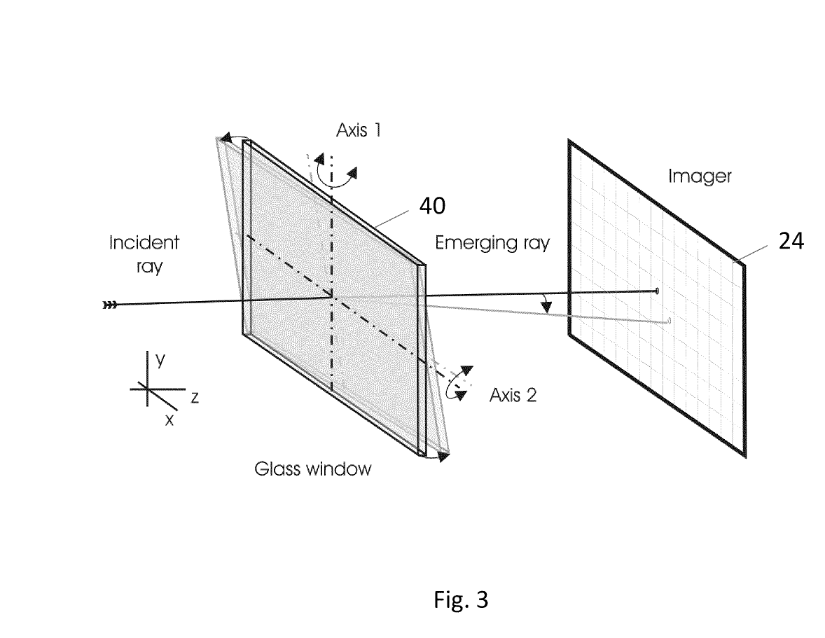

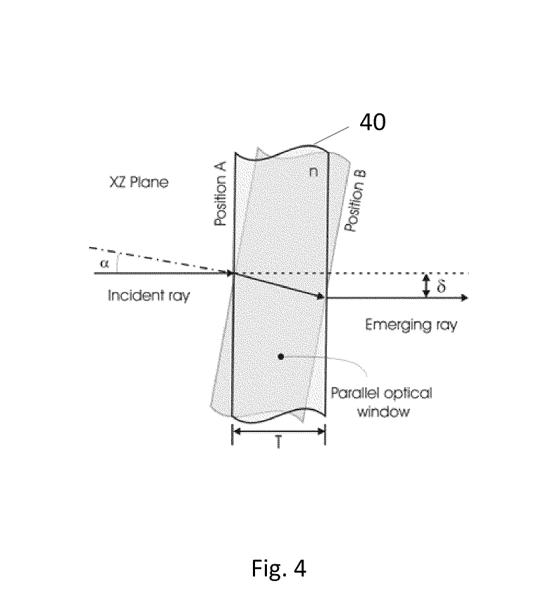

A parallel optical window 40 may be used as the filter element 34 because when an incident ray is not perpendicular to the window, the emergent ray is laterally displaced. The operation of the optical window 40 as a filter element is shown in FIGS. 3 and 4. When the window is in neutral position (position A) then the incident ray is perpendicular to the surface of the window. Position B marks a location of the window when it is rotated at angle α relative to the neutral position. When a parallel optical window with a thickness T and a refraction index n is tilted in the optical path, then the ray incident at an angle α is displaced laterally by amount δ, given by:

$$δ = \frac{T sin ( α ) ( 1 - \sqrt{1 - {sin}^{2} ( α )} )}{\sqrt{{n}^{2} - {sin}^{2} ( α )}}$$

As shown in FIG. 3, rotation around axis Y results in a displacement in the XZ plane and rotation around axis X results in displacement in the YZ plane. By rotating the window in both XZ and YZ planes, the incident ray may be laterally moved in two dimensions across the imager. As shown in FIG. 4, when using an optical window, the emergent ray is parallel with the incident ray and the lateral displacement of rays at the imager is not a function of distance between the window and the imager. Therefore, the use of an optical window as the filter element 34 is advantageous, because precise positioning of the window between the lens and the imager is not required.

The physical dimensions of the optical window 40 are determined based in part on the optical dimensions of the imager 24. The window should not limit the light bundle between the lens 28 and the imager 24. Imager sizes and formats vary, but typical imagers have diagonal lengths of from about 2 mm, up to about 55 mm. For example, for a 1″ imager with a diagonal length of about 16.0 mm, a square optical window with 25 mm sides is sufficiently large to avoid any image vignetting.

The thickness of the optical window is governed in part by two factors: thicker glass results in more lateral displacement of the emergent ray, but increased thickness leads to increased total weight of the window, which requires more force to achieve necessary angular acceleration and velocity. Required lateral displacement is determined based in part on the desired frequency response of the optical low-pass filter, which in turn is based in part on the imager photosite size. The optical window may be made from, for example, clear, colorless glass, such as B270 glass available from S.I. Howard Glass, Worcester, Mass. Other materials with similar or better performance, such as crown glass, including BK7 glass, sapphire etc. or even materials such as germanium that would function in the infrared spectrum can also be used. Preferably, the window is coated with an antireflective coating.

### A Rigid Mirror Based Optical Low-Pass Filter

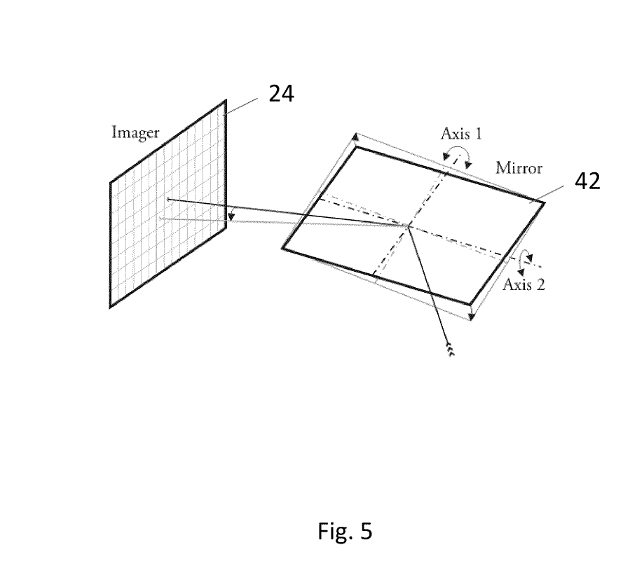

A rigid mirror 42 may be used as the filter element 34 because rotation of the mirror displaces the image on the imager. Operation of the mirror 42 as a filter element is shown in FIG. 5. When the mirror 42 is rotated, the reflected ray is moved to a different portion of the imager. By rotating the window in two different planes, the reflected ray may be laterally moved in two dimensions across the imager. As shown in FIG. 5, when using a rigid mirror, the reflected ray is not parallel with the incident ray and the lateral displacement of rays at the imager is therefore a function of distance between the mirror 42 and the imager.

As with the window 40, the physical dimensions of the mirror 42 are determined based in part on the optical dimensions of the imager 24. The mirror should not limit the light bundle between the lens and the imager.

### The Manipulator and the Controller

The filter element 34 is subject to small, rapid movements by the manipulator 36. Preferably, the manipulator 36 includes two separate linear or rotary actuators, one for each axis of desired rotation. In an embodiment, the linear actuators are piezo motors, such as motor P-653 from PI (Physik Instruments) in Irvine, Calif. Additional actuators usable in the present invention are Squiggle® Motors from New Scale Technologies, Inc., Victor, N.Y. 14564. Various types of voice coil actuators can also be used. The choice of manipulator, or actuator, is based in part on one or more of the characteristics of the filter element, the desired number of steps during the anticipated exposure time, and the desired distance between steps. As discussed herein, the desired number of steps and distance between steps is determined in part on the characteristics of the lens and imager. Preferably, the actuators are small enough to fit within a portable image capture device. Preferably, the actuators consume little power and can be powered by a battery in a portable image capture device.

The controller 38 for the manipulator 36 can be separate from the digital imaging device controller or integrated therewith. The controller can be a general purpose microcontroller, such as Controller Model No. SC143 from Beck IPC GmbH, Pohlheim, Germany.

### Operation of the Dynamic Optical Low-Pass Filter

During imager exposure, the filter element 34 (e.g. optical window 40 or mirror 42) may rotate around one or more axes and, as a consequence, result in a one-dimension or a two-dimensional lateral displacement of the image on the imager. The filter element 34 may be moved in discrete steps, which results in a finite number of lateral displacement steps of the image during the exposure. If the time that the filter element spends traveling from one position to another is small relative to the exposure time, then the output of the imager after exposure will be a sum of the finite number of images that are spatially shifted relatively to each other.

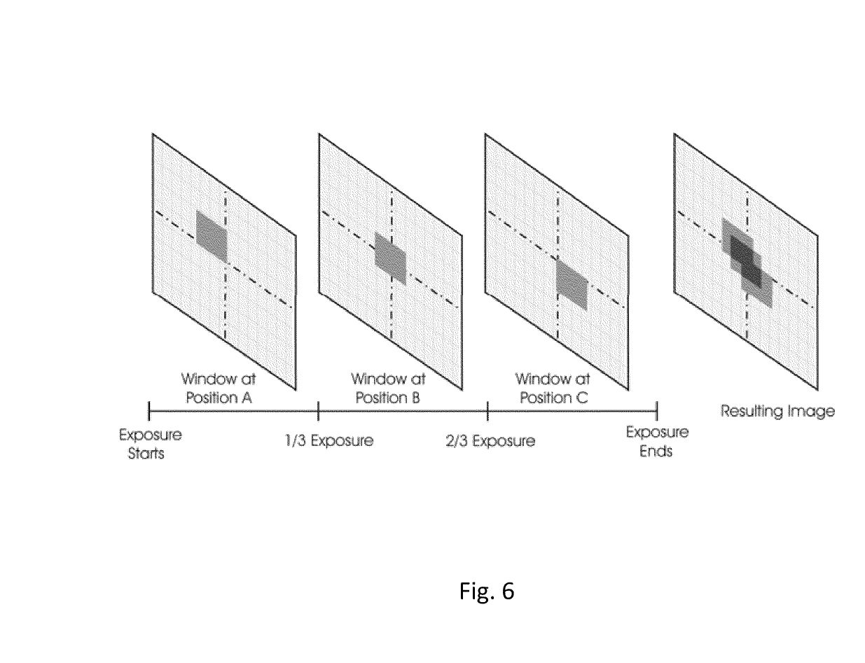

FIG. 6 illustrates an example of when the filter element 34 laterally displaces an image formed on the imager 24 in several discrete steps. In the example of FIG. 6, during a single exposure, the filter element 34 is moved three times, which results in lateral movement of the projected image on the imager to three different locations. After the image exposure is over, all different image positions are integrated.

Positions of a shifted continuous scene on the imager depend on the continuous angles that the filter element travels around axes. The lateral displacements of the image determines the spatial position of impulses in the two-dimensional impulse response of the filter.

The amplitude of the impulses is determined by the time that the filter element spends at each discrete position. By altering the amount of time that the filter element spends at each discrete position, various known shapes, or window functions, can be employed to further enhance the effectiveness of the filter. Examples of possible window functions include, rectangular, Tukey, Hanning, triangle, Blackman-Harris and Gaussian, Riesz, Riemann, and Poisson window functions.

As used herein the term “tap” refers to a specific orientation of the filter element 34 and consequent placement of light from an image onto a particular location of the imager. Multiple taps refers to different orientations of the filter element 34 and consequently different placements of light from an image onto different locations of the imager.

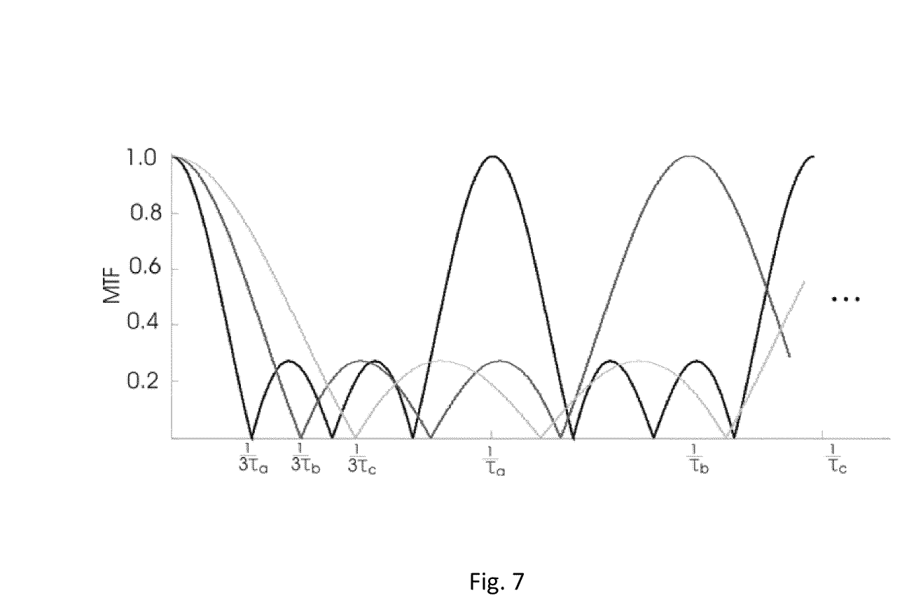

The number of filter element taps and the amplitude of the taps determines the shape of the frequency response of the dynamic optical low-pass filter. FIG. 7 shows the theoretical modulation transfer functions of a three-tap filter with three different spatial distances between taps. Increasing and decreasing the distance between taps stretches and contracts the frequency response of the filter. The dynamic optical low-pass filter described herein can control the distance between taps and the dwell time of each tap with fine precision, thereby resulting in fine control of the resulting filter's shape and bandwidth.

There are several instances in which it is desirable to change the characteristics of the optical low-pass filter in a controlled way, such as for example when different lenses are used, the aperture or the focal length of a mounted lens is changed, the characteristics of an imager change due to pixel binning or sub-sampling and when the digital imaging device is subject to motion.

There are multiple factors that affect the modulation transfer function of a given lens. Preferably, the dynamic optical low-pass filter controller 38 controls the manipulator 36 to alter at least one of the number of taps, time spent at specific tap locations (which changes the amplitudes of certain taps), and distance between taps depending on the attributes of any given lens. However, one factor with high impact on the lens modulation transfer function is diffraction limitation caused by lens aperture which is expressed in F-number. Varying the lens aperture alters the frequency content of the formed image. In general, as the lens aperture is increased, higher frequencies are less attenuated. Conversely, when the lens aperture is reduced, less light is allowed to get through to the imager and high frequencies are more attenuated.

The imaging system modulation transfer function (MTF) is the cascade of all the modulation transfer functions of the system elements. If the aperture of the lens is at its optimal value, then the low-pass filtering effect is mostly a result of the optical low-pass filter. As the lens aperture is closed (increasing the F-number), the inherent low-pass filtering effect of the lens has more and more influence on the combined modulation transfer function. When the lens is at the high F-number, the low-pass filtering of the combined modulation transfer function is mostly the result of the lens modulation transfer function. At that point, the optical low-pass filter is redundant and its use would degrade image performance.

Therefore it would be desirable to change the characteristics of the optical low-pass filter and possibly disable the optical low-pass filter as the lens aperture is altered. In a preferred embodiment of the present invention, the image capture device controller 30 communicates with the lens 28 to determine the F-number of the lens at the time of exposure and then communicates with the dynamic optical low-pass filter controller 38. The dynamic optical low-pass filter controller 38 controls the manipulator 36 to alter at least one of: the number of taps, time spent at specific tap locations and distance between taps depending on the F-number of the lens. Preferably, the dynamic optical low-pass filter controller 38 prevents the manipulator 36 from moving the filter element 34 if the F-number of the lens 28 is equal to or greater than 11. More preferably, the dynamic optical low-pass filter controller 38 prevents the manipulator 36 from moving the filter element 34 if the F-number of the lens 28 is equal to or greater than 16. Even more preferably the dynamic optical low-pass filter controller 38 prevents the manipulator 36 from moving the filter element 34 if the F-number of the lens 28 is equal to or greater than 22.

Some imagers decrease the number of imaging elements that are being transferred off-chip to increase the frame rate or sensitivity. There are two ways to do this operation on-chip: one is binning and another one is spatial sub-sampling. In a binning process, two or more imaging elements are tied together and transferred off-chip as one value. Binning can be deployed in a horizontal direction, a vertical direction, or in both directions. The spatial sub-sampling approach only transfers selected imaging elements off-chip. For example, every second vertical imaging element may be transferred off-chip. In binning and sub-sampling the distance between centers of captured imaging elements is changed and, as a result, the Nyquist frequency of the imager is lowered, which can lead to aliasing.

Preferably, the image capture device controller 30 communicates any binning or spatial sub-sampling information to the dynamic optical low-pass filter controller 38. The dynamic optical low-pass filter controller 38 controls the manipulator 36 to alter at least one of: the number of taps, time spent at specific tap locations, and distance between taps depending on the nature of any binning or spatial sub-sampling.

Although there may be some exceptions, such as when the exposure time is very short, movement of the image capture device 20 during an exposure causes some image blurring. Thus, movement of the image capture device 20 during an exposure functions as a low-pass filter. Accordingly, there is less need for the dynamic optical low-pass filter 26 in situations where the image capture device 20 is being moved. Preferably, the image capture device 20 has a motion sensor 32. The image capture device controller 30 communicates with the motion sensor 32 to determine whether the image capture device is moving at the time of exposure and then communicates with the dynamic optical low-pass filter controller 38. The dynamic optical low-pass filter controller 38 controls the manipulator 36 to alter at least one of the number of taps, tap dwell time, and distance between taps, as a function of motion of the of the image capture device. Preferably, the dynamic optical low-pass filter controller 38 prevents the manipulator 36 from moving the filter element 34 if movement of the image capture device is detected.

### EXAMPLE

To test the efficacy of a dynamic optical low-pass filter according to an embodiment of the present invention, a test fixture was constructed. A parallel optical window having length, width and depth dimensions of 25 mm×25 mm×2 mm and made of B270 glass, specifically Techspec® B270 from Edmund Optics Inc., Barrington, N.J., was obtained and mounted on an aluminum frame. The frame had one degree of freedom and could rotate only around a vertical axis. While for use in two-dimensional spatial filtering, the dynamic optical low-pass filter would typically rotate around two axes, this example was used to prove the dynamic optical low-pass filter concept. The window was mounted on a larger rigid frame having a linear piezo motor, Model No. P-653 from PI (Physik Instruments) in Irvine, Calif. The combination was then attached to a plate that was in turn fixed to an optical bench.

The frame with the window is subject to rapid movement. The total weight of the frame with the optical window was 5.3 grams. The piezo motor is a miniature linear motor with 2 mm travel range and velocity up to 200 mm/s. The piezo motor was controlled in an open loop by a custom built microprocessor board which allowed precise timing. The microprocessor board was relatively simply in construction, because the piezo motor only required two-control signals (move left-move right) and power, so a two-pin microcontroller/microprocessor could control the motor.

The motor was attached to the frame at the edge of the window at 12.5 mm from the axis of rotation. For every micrometer of piezo motor travel, the window rotated 0.00458°. The travel range of the motor is 2 mm which led to a maximum rotation of approximately 9.2°. Given the thickness of the window (2 mm) and the refractive index of the window (1.53), every micrometer of piezo motor travel, the passing rays were laterally displaced by approximately 55 nanometers (μm). The pixel pitch in an Olympus E-510 digital still camera is 4.7 μm. The birefringent filter used in the Olympus E-510 has a lateral ray displacement similar to the pixel pitch. To obtain the same results with the dynamic optical low-pass filter, the window was required to rotate 0.391°, which corresponds to an 85 μm long linear motion of the piezo motor.

The camera, Model No. GE1900 by Prosilica Inc., a subsidiary of Allied Vision Technologies, Inc., Newburyport, Mass., was mounted on a linear stage with a micrometer. The window frame was placed between the camera and a lens mount with a 55 mm Nikon lens. The window, the lens mount and the lens were fixed to the optical bench. The coarse focusing was accomplished with the lens, while the fine focusing was accomplished with back focusing using the micrometer. The lens was set to F8.0. The dynamic optical low-pass filter and the camera were connected to a microprocessor board which provided timing and synchronization with 1 μs resolution.

Captured frames were transferred to a personal computer via an Ethernet cable for image processing and modulation transfer function estimation. The ability to focus on a target and a determination that vignetting was negligible was determined upon setting the experiment.

### Results From the Example

The frequency response of the dynamic optical low-pass filter was observed in combination with the other optical elements (a Nikon 55 mm lens with aperture set at F8.0) and a custom designed test target with 67 frequencies. Projected onto the sensor, the target contained all frequencies from 0 to the Nyquist frequency of the sensor, which was 67 lp/mm, in 1 lp/mm increments. The distance between taps and their amplitudes were designed to set the first zero-crossing of the frequency response at 30 lp/mm and attenuate frequencies above 30 lp/mm. Setting the zero-crossing frequency at 30 lp/mm allowed for study of the characteristics of the dynamic optical low-pass filter above the cut-off frequency. From the different known window functions, the rectangle, triangle, Gaussian and Blackman-Harris were chosen to demonstrate possible levels of dynamic optical low-pass filter control.

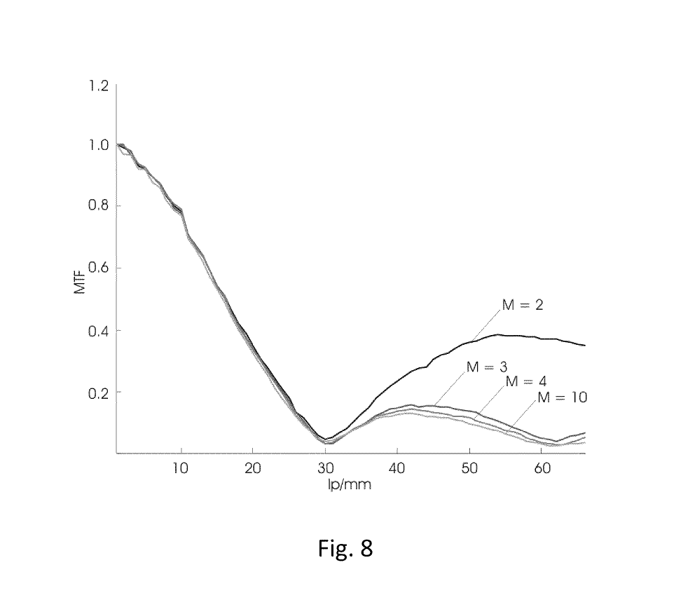

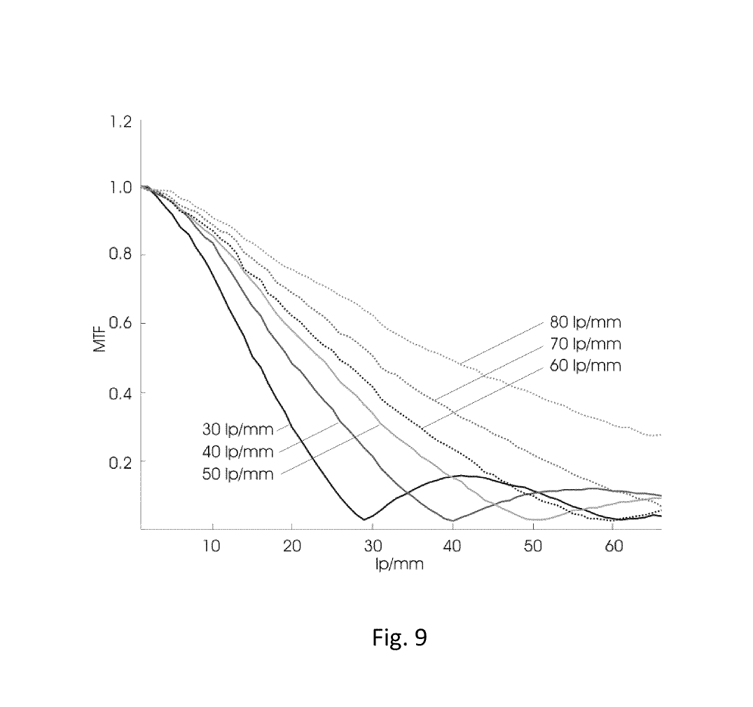

FIG. 8 shows four test system modulation transfer function measurements with a rectangle filter having 2, 3, 4 and 10 taps. For each filter, the first zero-crossing was set at 30 lp/mm. As seen in FIG. 8, the benefit of using more than a 3-tap or 4-tap rectangle filter is minimal. FIG. 9 shows six test system modulation transfer function measurements with a rectangle filter having three-taps of varying distances. FIG. 9 demonstrates the ability to control bandwidth of a given filter by controlling the distance between taps. As seen in FIG. 9, as the distance between taps in the three-tap filter increases, the zero-crossing frequency (cut-off) gets lower.

During some tests, the amplitude of taps was varied (by varying the time that dynamic OLPF spent at each tap) to effect additional windows including triangle, Gaussian and Blackman-Harris filters. The results of those tests showed that the dynamic optical low-pass filter described herein allows for use of other known window functions including Tukey, Hanning, Riesz, Riemann, and Poisson.

Although the present invention has been described in considerable detail with reference to certain preferred versions thereof, other versions are possible. Therefore, the spirit and scope of the appended claims should not be limited to the description of the preferred versions described herein.

All features disclosed in the specification, including the claims, abstract and drawings, and all the steps in any method or process disclosed, can be combined in any combination except combinations where at least some of such features and/or steps are mutually exclusive. Each feature disclosed in the specification, including the claims, abstract, and drawings can be replaced by alternative features serving the same, equivalent or similar purpose, unless expressly stated otherwise. Thus, unless expressly stated otherwise, each feature disclosed is a one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

What is claimed is:

1. A filter system for use with an image capture device having an imager with a plurality of imaging elements, the filter system comprising:
a. a filter element for movably directing light to different imaging elements on the imager; and
b. a manipulator for changing the orientation of the filter element during an exposure to achieve an optical low-pass filter.

2. The filter system of claim 1 wherein the filter element is a parallel optical window.

3. The filter system of claim 1 wherein the filter element is a rigid mirror.

4. The filter system of claim 1 wherein image capture device further comprises a lens; and wherein the filter element is positionable between the imager and the lens of the image capture device.

5. The filter system of claim 1 further comprising a filter controller for controlling the manipulator.

6. The filter system of claim 5 further comprising a motion sensor electrically coupled to the filter controller; and wherein the filter controller is configurable to modify the low pass filter or disable the manipulator in response to motion sensed by the motion sensor.

7. The filter system of claim 5 wherein the image capture device further comprises a lens having a plurality of different apertures; and wherein the filter controller is configurable to modify the low pass filter or disable the manipulator depending on the lens aperture.

8. A method for filtering image frequencies in an image capture device having a lens, an imager having a plurality of imaging elements, a rotatable filter element positioned between the lens and the imager, and a controller, the method comprising the step of rotating the filter element in a predetermined pattern to move an image to at least two different locations on the imager during an exposure.

9. The method of claim 8 wherein the filter element is rotated to move the image to at least 4 different locations on the imager during an exposure.

10. The method of claim 8 wherein the filter element is rotated to move the image in two dimensions.

11. The method of claim 8 wherein the image capture device further comprises a motion sensor and the method further comprises the step of altering the pattern of filter element rotation to change at least one of: the number different image locations, the time spent on at least one image location, and the distance between image locations during an exposure in response to motion sensed by the motion sensor.

12. The method of claim 8 wherein the image capture device further comprises a motion sensor and the method further comprises the step of disabling rotation of the filter element in response to motion sensed by the motion sensor.

13. The method of claim 8 wherein the lens in the image capture device is interchangeable and the image capture device further comprises a memory for storing information about various lenses; and wherein the method further comprises the steps of:
identifying the lens;
retrieving from the memory information about the identified lens; and
altering the pattern of filter element rotation to change at least one of: the number of different image locations, the time spent on at least one image location, and the distance between image locations during an exposure in response to information about the identified lens.

14. The method of claim 8 further comprising the steps of:
determining an aperture setting of the lens; and
altering the pattern of filter element rotation to change at least one of: the number of different image locations, the time spent on at least one image location, and the distance between image locations during an exposure in response to the aperture setting of the lens.

15. The method of claim 8 further comprising the steps of:
determining an aperture setting of the lens; and
disabling rotation of the filter element in response to an aperture setting higher than F16.

16. The method of claim 8 further comprising the step of:
altering the pattern of filter element rotation to change at least one of: the number of different image locations, the time spent on at least one image location, and the distance between image locations during an exposure with pixel binning or sub-sampling in the imager.

17. The method of claim 8 wherein the filter element is rotated to place the image at different locations on the imager for different lengths of time.

18. An image capture device comprising:
a. a lens having a variable aperture;
b. an imager having a plurality of imaging elements; and
c. a means for movably directing light to different imaging elements on the imager, the means for movably directing light being positioned between the lens and the imager; and
wherein the means for movably directing light moves an image to at least two different locations on the imager during an exposure to achieve an optical low-pass filter.

19. The image capture device of claim 18 further comprising a controller electrically coupled to the lens, the imager, and the means for movably directing light; and wherein the controller is configured to control the means for movably directing light to change at least one of: a number of different image locations, a time spent on at least one image location, and a distance between image locations during an exposure in response to an aperture setting of the lens.

20. The image capture device of claim 18 further comprising a motion detector for detecting motion of the image capture device and a controller electrically coupled to the lens, the imager, the means for movably directing light and the motion detector; and
wherein the controller disables the means for moving light in response to motion detection by the motion detector.
